(19) United States
(12) Patent Application Publication
(10) Pub. No.: US 2011/0250314 A1
(43) Pub. Date: Oct. 13, 2011

(54) Activated Cranberry Powder

(76) Inventor: Bernard G. Lager, II, Wisconsin Rapids, WI (US)

(21) Appl. No.: 13/166,843

(22) Filed: Jun. 23, 2011

Related U.S. Application Data
(63) Continuation of application No. 11/880,012, filed on Jul. 19, 2007, now abandoned.
(60) Provisional application No. 60/831,987, filed on Jul. 19, 2006.

(51) Int. Cl. A23L 1/29; A23L 1/212

(52) U.S. Cl. 426/50; 426/648

(57) ABSTRACT

An active fruit powder is produced from fruits which include components resistant to digestion. The process includes macerating the fruit to yield a pomace slurry adding water to the process if necessary and adding enzymes to the slurry in an amount sufficient to provide the molecular breakdown of the cranberry. Examples of suitable enzymes include pectin esterase (pectinase), depolymerase, cellulase, hemicellulase, manannase, galactosidase, xylanase and glucanase. The slurry is preferably heated and agitated.

### CROSS-REFERENCE TO RELATED APPLICATIONS

Priority is hereby claimed to provisional application Ser. No. 60/831,987, filed Jul. 19, 2006, which is incorporated herein by reference.

### FIELD OF INVENTION

The present invention relates to a cranberry powder, a cranberry liquid and method of making cranberry powder and liquid and products comprising this cranberry powder and liquid.

### DESCRIPTION OF THE PRIOR ART

American cranberry (Vaccinium macrocarpon) is a native plant of North America found in acidic peat bogs. The plant is domestically cultivated to produce fruit for processing and fresh consumption. The fruit is grown in the northeast, upper mid-west, northwest and Canada.

Processors have typically relied upon juice extraction and concentration of that juice to provide cranberry nutrition to the consumer. This juice and concentrate are devoid of many of the nutritional components of the original fruit.

Some processors have dried the whole fruit and purees of the fruit. This dried material is then milled and delivered as a powder. The act of drying the fruit does not completely unlock the nutritional components.

Usually, powdered forms of cranberries and of many other fruits, produced for use as ingredients, are made from the juice portion of the fruit only. The juice is extracted from the whole fruit by pressing and then concentrating. During this stage, the plant-derived fiber portion, otherwise known as the pomace or marc, of the fruit is discarded, and the natural pectin in the juice is removed. The remainder fruit juice product is then spray-dried, using a high-heat drying method to remove most of the moisture, which reduces it to a powder. This final powder ingredient is a substantially-depleted version of the whole fruit plant, bearing little resemblance to the values contained in the complete fruit.

These powdered fruit ingredients, now devoid of many of the important active components and enzymes which synergistically existed in the whole fruit plant, deliver little therapeutic value when incorporated into nutraceutical products. For example, many of the cranberry dietary supplements sold in the marketplace today indicate a dosage requirement of as many as six to twelve tablets or capsules a day because of the weak efficacy of the powdered cranberry ingredient used.

Thus, there is a distinct need for a new method which will produce new, enhanced fruit ingredients, and for a method to produce improved cranberry and other fruit powdered compositions, which are not as depleted as described and which instead incorporate all, or even more, of the values contained in the original fruits.

### SUMMARY

The present invention is directed to a process for producing an active fruit supplement from fruit, wherein the fruit includes components resistant to digestion. The process comprises macerating the fruit to yield a fruit pomace slurry; adding enzymes to the slurry in an amount sufficient to provide the molecular breakdown of the fruit; and heating the slurry to a temperature not exceeding about 100° F. with agitation. If necessary, water can be added at a rate of 5-8% by weight. The slurry can be agitated for a time not to exceed four hours. If desired, the slurry can be dried to a moisture content less than about 15% by weight to form a dried active fruit product. Drying conditions are under temperature conditions not exceeding 140° F.

The enzymes are added in an amount sufficient to effect substantial hemicellulose and cellulose hydrolysis and the substantial breakdown of colloidal and soluble pectin in the fruit, and the depolymerization of the structural and non-structural polysaccharides in the fruit walls. The enzymes are selected from the group consisting of pectin esterase (pectinase), depolymerase, cellulase, hemicellulase, manannase, galactosidase, xylanase and/or glucanase.

The present invention also contemplates a process for producing an active cranberry powder from cranberry, wherein the cranberry includes components resistant to digestion. The process includes macerating the cranberry to yield a cranberry pomace slurry having a particle size approximately 1 mm, adding water to the cranberry during the maceration process, wherein water is added at a rate of 5-8% by weight, adding enzymes to the slurry in an amount sufficient to provide the molecular breakdown of the cranberry, wherein the enzymes are selected from the group consisting of pectin esterase (pectinase), depolymerase, cellulase, hemicellulase, manannase, galactosidase, xylanase and/or glucanase, heating the slurry to a temperature not exceeding about 140° F., agitating the slurry for a time not to exceed four hours, and drying the slurry under temperature conditions not exceeding 140° F. to a moisture content less than about 15% by weight to form a dietary supplement.

The present invention is further directed to an active fruit supplement produced by the processes described above.

Enzymes added to fruits during process can release the nutritional components bound up in cells. Pectin and complex polysaccharides inhibit the release of important nutritional molecules found in the cranberry fruit.

Enzymatic synergies provide opportunities to select and break down complex polysaccharides. These structural carbohydrates are resistant to digestion and absorption. These enzymes are used to be effective in the range of pH 2.5 to 3.5, typical of cranberry.

In one product aspect, the invention comprises liquid slurry. The liquid has particle sizes not exceeding 1 mm. The color and aroma comprise a characteristic cranberry identity. The solids identified by centrifugation will not exceed 40%.

Advantageously, the Active Cranberry Powder product of the present invention is made without the use of any carriers, excipients or non-natural processing aids. The Active Cranberry Powder product of the present invention is produced in a manner free of irradiation. The Active Cranberry Powder product of the present invention is produced in a manner free of protein derived from milk, eggs, fish, crustaceans, shellfish, tree nuts, peanuts, wheat or soybeans, thus being free of most allergens. The Active Cranberry Powder product of the present invention is produced using a 100% natural process. No artificial or synthetic additives or aids are used in production.

The active cranberry powder of the present invention has a variety of uses, including nutritional bars, nutritional beverages, functional, i.e. fortified, foods, and dietary supplements. Nutritional bars can gain color, flavor and nutrient enhancement with as little as one-fourth percent of active cranberry powder added on a dry weight basis. Nutritional beverages such as dry tea can gain flavor, color and nutrition by adding 0.5 to 2 grams of active cranberry powder. The addition of this material introduces a noticeable cranberry flavor. The functional, i.e. fortified, foods manufactured with heat (as in baking, extruding or frying) retain the color and nutritional qualities of active cranberry powder very well. The active cranberry powder is blended into the dry ingredients portion of a formula between 1% and 10% for color, flavor and nutritional fortification. The color of active cranberry powder shows well in meat products like sausages and ground jerkies while adding nutritional characteristics not typically found in such foods. Dietary supplements that use soft gel and two-piece capsule applications will find that the active cranberry powder adds superior cranberry constituents to many formulas. The active cranberry powder can be blended with other fruit concentrates to achieve superior levels of phenols, antioxidants and minerals.

The objects and advantages of the invention will appear more fully from the following detailed description of the preferred embodiment of the invention.

### DETAILED DESCRIPTION

The manufacturing process of Active Cranberry Powder (ACP) of the present invention begins with the selection of fruit. While the present invention will be described with specific reference to cranberries, it is within the scope of the present invention to utilize other fruits or combinations of fruits, including but not limited to, cranberries, blueberries, lingonberry, aronia, bilberries, raspberries, huckleberry, blackberry, and black raspberry. To achieve maximum benefit from the invention, it is preferred that the fruit include components resistant to digestion.

Dark pigmented fruits are generally considered to contain more bio-active components by weight per weight than the same fruit of a lighter color. The cranberry industry has a scale of color, with commercial harvested fruit of the lightest color (closest to white) as zero and the darkest fruit, from the given season, being a color six. All other fruit falls into categories one through five. In any given year, the actual objective number may have subjective influence to average the bulk of the harvest between three and five. This allows fruit to be pulled from storage and blended by number. This keeps the processed juice a consistent color throughout the year.

The first step in selecting fruit for ACP production is setting a standard of color four or better. Along with this, rot, debris and foreign material must preferably be below about 0.5% by weight. Acid by filtration for total acids must preferably exceed about 1.5% total weight, with quinic acid, tested by HPLC, comprising no less than about 28% of the organic acid profile.

Enzyme activity is paramount to the production of ACP. The enzyme additions are designed to include a combination of commercially available enzymes and provide a synergistically superior process, as a multi-component enzyme system for particle size reduction of the nutritional components of the cranberry fruit.

The present invention contemplates the addition of enzymes including, but not limited to, the following: pectin esterase (pectinase), depolymerase, cellulase, hemicellulase, manannase, galactosidase, xylanase and glucanase.

Advantageously, these enzymes break down soluble and colloidal pectin, araban and complex polysaccharides. In addition, the structural plant carbohydrate, cellulose, and non-structural, viscosity-forming polysaccharides will be degraded and broken down. Further, cell wall matrixes will be broken to help release proteins. Further still, pentosans, mannans and xylans present in the seed and cuticle of the fruit will be broken down. In addition, the color and nutritional aspects of anthocyanins will be enhanced and protected by the avoidance of anthocyanase.

Considerations of select enzymes for Active Cranberry Powder include activity levels, pH, temperature, and time relationships. The enzyme system must allow the depolymerization of the structural and non-structural polysaccharides.

Many components within the cranberry fruit are resistant to digestion and absorption. To expose many of these components and provide for complete cellulose hydrolysis, the cellulose combinations provided in the selection provide endo- and exocellulase and betaglucosidase activity.

Hemicellulose is a primary component in cranberry cell walls. The selection for ACP is designed to include Hemicellulase to hydrolyze these components and reduce viscosity and to increase the overall enzyme activity.

The colloidal and soluble pectin found in cranberries is also a factor in inhibiting digestion and absorption of cranberry nutritional actives.

Color retention in the finished ACP is critical. Much of the color associated with the dark red cranberries is proanthocyanins and anthocyanidins. The system selected avoids anthocyanase activity, keeping these most important cranberry actives intact.

As stated before, the present invention contemplates the addition of enzymes including, but not limited to, the following: pectin esterase (pectinase), depolymerase, cellulase, hemicellulase, manannase, galactosidase, xylanase and glucanase.

Depolymerase is added in an amount sufficient to effect substantial depolymerization of the structural and non-structural polysaccharides in the fruit walls. The enzyme is added in an amount typically from 0.0000001 to 2.00% by weight, and preferably from 0.0001 to 0.001% by weight. Unless otherwise indicated, percentages appearing in this disclosure refer to weight percentage of the subject formulation.

Cellulase is added in an amount sufficient to effect substantial cellulose hydrolysis in the fruit. The enzyme is added in an amount typically from about 0.0000001 to 2.00% by weight, and preferably from 0.00001 to 0.0001% by weight.

Hemicellulase is added in an amount sufficient to effect substantial hemicellulose hydrolyzation in the fruit. The enzyme is added in an amount typically from about 0.0000001 to 2.00% by weight, and preferably from about 0.00001 to 0.0001% by weight.

Pectin esterase (pectinase) is added in an amount sufficient to effect the substantial breakdown of colloidal and soluble pectin in the fruit. The enzyme is added in an amount typically from about 0.0000001 to 2.00% by weight, and preferably from about 0.00001 to 0.0001% by weight.

Further, glucanase, manannase, galactosidase and xylanase are added in amounts sufficient to effect the substantial breakdown of glucans, pentosans, mannans and xylans present in the seed and cuticle of the fruit. Glucanase and xylanase are added in an amount typically from about 0.0000001 to 2.00% by weight, and preferably from about 0.00001 to 0.0001% by weight.

Manannase is added in an amount typically from about 0.0000001 to 2.00% by weight, and preferably from about 0.00001 to 0.0001% by weight.

Galactosidase is added in an amount typically from about 0.0000001 to 2.00% by weight, and preferably from 0.00001 to 0.0001% by weight.

The enzymes can be added to the slurry mixture incrementally or in combination.

Non-limiting examples of suitable enzymes for use in the present invention can be found in the following Valley Research (South Bend, Ind.) products: Validase TR2, Validase ANCL and Crystalzime 200XL (Pectinase/Arabinase), and the following BIO-CAT Inc. (Troy, Va.) combination products: BIO-CAT Cellulase, BIO-CAT

Hemicellulase and BIO-CAT Pectinase. All of the BIO-CAT products can be formulated to provide the molecular breakdown of the fruit to make Active Cranberry Powder.

A typical batch of enzymes for processing 3,000 pounds of Grade 4 color fruit or better along with 5-8% additional process water would include:

| | |
|---|---|
| 2 oz. BIO-CAT Cellulase | 200,000 cellulase |
| | unit per gram (CU/G)* |
| 2 oz. BIO-CAT Hemicellulase | 400,000 hemicellulase |
| | unit per gram (HCU/G)* |
| 1 oz. BIO-CAT Pectinase | 1,000,000 apple juice |
| | depectinizing units (AJDU) |
| 10 oz. Validase TR2 | |
| 10 oz. Validase ANCL | |
| 10 oz. Crystazime 200XL | |

*The designations are proprietary activation measurements of enzyme activity per gram from BIO-CAT.

Once the fruit is selected, the particle size of the fruit must be reduced preferably to a maximum size less than 1 mm to complete the manufacture of the finished ACP. The size reduction parameter ensures that all of the fruit, including the skin, cuticle, seeds, and other parts of the fruit, are mechanically opened up to allow maximum enzyme exposure. This enzyme exposure will further reduce the particle sizing.

The physical maceration of the plant material has been known for millennia. The fruit can be processed as soon as practicable after harvest using any type of suitable means for pressing. The fruit, if frozen, should be thawed to a temperature above 40° F. prior to maceration, to avoid icing.

For small batches, a hand-powered hydraulic basket press is suitable. For larger volumes of cranberries, industrial-sized equipment is required. One aspect of the invention is a process where the fruit is macerated using typical food processing equipment including but not limited to grinders, roller mills, plate mills and hammer mills. The fruit is reduced to particle sizes less than 1 mm in size. The type of maceration equipment used for this can be a CREPACO liquefier (APV Crepaco, Inc., Lake Mills, Wis.) or other similar type of readily available commercial equipment capable of the initial size reduction required. If desired, water can be slowly added at a rate of 5-8% by weight during the maceration process to assisting in the fruit maceration.

Any debris is removed from the juice by filtration. The resulting macerated fruit mass is called the pomace. It is preferred that the pomace be processed immediately after expression or promptly frozen for storage until further processing is undertaken.

In lieu of using a liquefier, an alternative process technique is to temper the fruit and run it through a hammer mill such as a Fitzmill Comminutor (The Fitzpatrick Company, Elmhurst, Ill.).

The macerated pomace slurry is then placed in an agitation tank. Agitation tanks are well known to the industry. Preferably, the tank is purged with inert gas, such as helium, nitrogen or hydrogen, to reduce oxidation during the processing. The agitation tank can be jacketed to provide heat to the pomace slurry.

The enzymes can be added directly into the agitation tank to mix with the pomace slurry. Alternatively, it is within the scope of the present invention to add the enzymes to the fruit pomace during the maceration procedure. The pomace slurry, the enzymes and any additives are mixed thoroughly to ensure that the entire bulk of the pomace is contacted by the enzymes.

The temperature of the slurry should not exceed 140° F. Preferably, this mixing is done at a temperature between about 40° F. and 75° F. The mixture is allowed to steep for up to 24 hours to allow the enzymes to be fully absorbed into the pomace.

In one product aspect, the invention comprises the resulting liquid slurry. The liquid has particle sizes not exceeding 1 mm. The color and aroma comprise a characteristic cranberry identity. The solids identified by centrifugation will not exceed 40%.

If drying is contemplated, the slurry is pumped to the dryer for water removal and packaging after the hold time is met. The enzymes and additional water can be streamed right into the mill with the fruit.

Drying is accomplished on drying racks using conventional drying techniques of spray, drum, microwave, convection, forced air, freeze or vacuum drying, conventional dehydrator, or by any other means for drying known to the art of food and pharmaceutical processing. Low-temperature drying means are greatly preferred. It is preferred that the moisture content of the dried mixture be less than 15% by weight, and preferably no more than about 3% by weight. Examples of drying techniques include window refractance drying (MCD Technologies, Inc., Tacoma, Wash.), three-phase drying (a low temperature proprietary process), or belt freeze drying (Mastertaste, Teterboro, N.J.).

The drying procedure preferably removes the water from the slurry while never allowing the temperature of the slurry solids to exceed 140° F. The finished, dried ACP is a hygroscopic material and must be packaged in such a way that there is a significant vapor barrier and all excess air must be removed from the package.

Parameters to consider as crucial for production of Active Cranberry Powder include:
Fast water removal;
Temperature control of slurry solids, never to exceed 140° F.; and
Control of air exposure to keep oxidation as low as possible.

The dried product so derived using cranberries as the starting plant material is called ACTIVE CRANBERRY POWDER or ACP. The ACP is then milled to a uniform size if desired. Generally, milling to a particle size below 1 mm and a mesh size of between about 20 and about 200 yields a product which readily flows and can easily be packaged, transported, and formulated into dosage form (if desired). A 20-200 mesh ACP powder is easily pelletized or capsulated using suitable and conventional machinery.

The ACP powder is hygroscopic and therefore does require the use of desiccants, either mechanical or with a drying aid. It should also be noted here that the product similarly produced from another plant source is also hygroscopic and does require the use of desiccants.

The ACP composition described herein, whether from cranberries or another plant source, either alone or in combination with other nutritionally significant compounds can be used in the formulation of dietary supplements, nutraceuticals, or pharmaceutical compositions for nutritional and/or medical use. Nutraceuticals are foods that have specific medicinal as well as nutritional benefits. The composition may be optionally formulated with an acceptable carrier or other therapeutically active ingredients. The carrier, if one is utilized, must be pharmaceutically acceptable in the sense of being compatible with the other ingredients of the formulation and not deleterious to the recipient thereof.

The formulations may conveniently be presented in unit dosage form and may be prepared by any of the methods well known in the art of pharmacy. All methods include the step of shaping the product into desired unit dosage form or packaging the product into unit dosages, such as capsules. If a carrier is used, such methods also generally include the steps of bringing the active compound into association with a carrier and one or more optional accessory ingredients. In general, the formulations are prepared by uniformly and intimately bringing the active compound into association with a liquid or solid carrier and then shaping or packaging into discrete unit dosages.

Formulations of the present invention suitable for oral administration may be presented as discrete units such as capsules, cachets, tablets, boluses or lozenges, each containing a predetermined amount of the ACP product as a powder or granules or small fibers.

A tablet may be made by compression or molding, optionally with one or more accessory ingredients. Compressed tablets may be prepared by compressing the ACP powder in a suitable machine in a free-flowing form, e.g., a powder or granules, optionally mixed with accessory ingredients, e.g., binders, lubricants, inert diluents, surface active or dispersing agents. Molded tablets may be made by molding in a suitable machine, a mixture of powdered ACP powder with any suitable carrier (optional). The amount of ACP powder present may be in a unitized amount of between about 100 mg to about 500 mg.

The amount of the composition required to be effective for promoting and maintaining sound health, will vary with the plant material used in the formulation of the composition and the individual mammal being treated and is ultimately at the discretion of the individual, or medical or veterinary practitioner.

In general, the pharmaceutical compositions of this invention contain from about 50 to about 5000 mg of ACP powder, and preferably from about 300 to about 1000 mg of ACP powder, preferably in a unit dosage form. The recommended dosage of ACP powder is 1,200 mg a day, preferably in a single dose, which has been determined by laboratory analysis and confirmed by clinical evaluation.

In one product aspect, the invention comprises a liquid slurry. The liquid has particle sizes not exceeding 1 mm. The color and aroma comprise a characteristic cranberry identity. The solids identified by centrifugation will not exceed 40%.

In another product aspect, the invention comprises a powder. The powder is red in color. The powder is milled to a particle size below 1 mm.

In another aspect of both the liquid slurry and powder, the following attributes are noted on a dried solids basis:
Protein greater than 3%
Fat greater than 1%
Ash greater than 1%
Total digestible nutrients greater than 82%
Digestible energy greater than 1500 calories per pound
Metabolizable energy greater than 1500 calories per pound
Sulfur is less than 0.10%
Phosphorus is less than 0.15%
Potassium is less than 1.0%
Magnesium is less than 0.10%
Calcium is less than 0.15%
Sodium is less than 0.10%
Manganese is less than 30 parts per million
Iron is less than 250 parts per million
Copper is less than 150 parts per million
Zinc is less than 100 parts per million

In another aspect of the powder, the Oxygen Radical Absorbance Capacity is greater than 300 micromole Trolox Equivalents per gram.

In another aspect of the powder, the phenolics expressed as milligram gallic acid per gram exceeds 20.

In another aspect of the powder, the anthocyanin expressed as milligram cyanidine-3-glucoside equivalent per gram exceeds 1.2.

### EXAMPLES

The following Example is included solely to aid in a more complete understanding of the subject invention. The Examples do not limit the scope of the invention described herein in any fashion.

### Example 1

A typical batch of enzymes for processing 3,000 pounds of Grade 4 color fruit or better along with 5-8% additional process water would include:

| | |
|---|---|
| 2 oz. BIO-CAT Cellulase | 200,000 CU/G |
| 2 oz. BIO-CAT Hemicellulase | 400,000 HCU/G |
| 1 oz. BIO-CAT Pectinase | 1,000,000 AJDU |
| 10 oz. Validase TR2 | |
| 10 oz. Validase ANCL | |
| 10 oz. Crystazime 200XL | |

The fruit is processed into slurry in the macerator, with the addition of the enzymes while macerating. Temperature of slurry with enzymes and water is continuously blended or stirred while bringing the slurry temperature up to 100° F. The agitation and temperature are held for up to four hours. The product is then dried using window refractance drying (by MCD Technologies), three-phase drying (a low temperature proprietary process), or belt freeze drying such as that done by Mastertaste.

The resultant slurry is then pumped into a holding tank and heated, not to exceed 100° F., by a heat exchanger or a jacket on the tank. After the hold time is met, the slurry is pumped to the dryer for water removal and packaging.

The drying procedure must quickly remove the water from the slurry while never allowing the temperature of the slurry solids to exceed 140° F. The finished, dried ACP is a hygroscopic material and must be packaged in such a way that there is a significant vapor barrier and all excess air must be removed from the package.

The active cranberry powder of the present invention was made from the cranberries Vaccinium macrocarpon Ait. The powder had a reddish purple appearance and the odor of fresh cranberry fruit. Eighty percent of the particle size was able to flow through a 20-mesh screen. The powder had typically a twelve-month shelf life.

Analyzing the powder produced the following analysis:

Typical Analysis:

| Moisture: | 7.9% | |
|---|---|---|
| Protein: | 1.1% | |
| Carbohydrates | 9.0% | |
| Fat: | 2.0% | |
| Fatty acid Percentages | | |
| Saturated fat | 20.3% | |
| Monounsaturated | 16.3% | |
| Polyunsaturated | 63.4% | |
| Ash: | 1.2% | |
| Dietary Fiber: | 9.8% | |
| Bulk Density: | 48 | gm/100 ml |
| ORAC: | 385 | uM Trolox Equ/G |
| Fructose | 11.0% | Sugar |
| Glucose | 37.5% | Sugar |
| Sucrose | nd | |
| Maltose | 0.7% | Sugar |
| Lactose | nd | |
| Vitamin C | 93.8 | mg/100 g |
| Vitamin E | 7.5 | IU/100 g |
| Vitamin D | 29.0 | IU/100 g |
| Copper | 1.7 | ppm |
| Iodine | nd | |
| Calcium | 409 | ppm |
| Potassium | 4732 | ppm |
| Sodium | 602 | ppm |
| Iron | 38 | ppm |
| Magnesium | 353 | ppm |
| Phosphorus | 550 | ppm |
| Niacin | 0.71 | mg/100 g |
| Riboflavin | .06 | mg/g |
| Thiamine | 2.95 | mg/g |

1. A process for producing an active fruit supplement from fruit, wherein the fruit includes components resistant to digestion, comprising:
a. macerating the fruit at a temperature not exceeding about 140° F. to yield a fruit pomace slurry, wherein the fruit is selected from the group consisting of cranberries, blueberries, lingonberry, aroma, bilberries, raspberries, huckleberry, blackberry, and black raspberry;
b. adding enzymes to the slurry in an amount sufficient to effect molecular breakdown of the fruit, to effect substantial hemicellulose and cellulose hydrolysis and substantial breakdown of colloidal and soluble pectin in the fruit, and to effect depolymerization of the structural and non-structural polysaccharides in fruit walls of the fruit, wherein the enzymes comprise hemicellulase, cellulase, pectin esterase (pectinase), and depolymerase; and
c. heating the slurry to a temperature not exceeding about 140° F. with agitation to effect, in the slurry, molecular breakdown of the fruit, substantial hemicellulose and cellulose hydrolysis and substantial breakdown of colloidal and soluble pectin in the fruit, and to effect depolymerization of the structural and non-structural polysaccharides in fruit walls of the fruit.

2. (canceled)

3. The process of claim 1 wherein the fruit is cranberries.

4. The process of claim 1 wherein the pomace has a particle size after step (a) of approximately 1 mm.

5. The process of claim 1 further comprising adding water to the fruit during step (a).

6. The process of claim 1 wherein water is added during maceration step at a rate of 5-8% by weight.

7. (canceled)

8. The process of claim 1 wherein the enzymes further comprise a member are selected from the group consisting of mannanase, galactosidase, xylanase and/or glucanase.

9. The process of claim 8 wherein the enzymes are added in amounts as follows:
a. Pectin esterase (pectinase) between about 0.0000001 to 2.00% by weight;
b. Depolymerase between about 0.0000001 to 2.00% by weight;
c. Cellulase between about 0.0000001 to 2.00% by weight;
d. Hemicellulase between about 0.0000001 to 2.00% by weight;
e. Mannanase between about 0.0000001 to 2.00% by weight;
f. Galactosidase between about 0.0000001 to 2.00% by weight;
g. Xylanase between about 0.0000001 to 2.00% by weight; and/or
h. Glucanase between about 0.0000001 to 2.00% by weight.

10. The process of claim 1 further comprising agitating the slurry during step (c) for a time sufficient to reduce enzymatic activity to zero.

11. The process of claim 1 further comprising step (d) of drying the slurry after step (c) to a moisture content less than about 15% by weight to form a dried active fruit product.

12. The process of claim 11 wherein the slurry is produced and dried during steps (a) through (d) under temperature conditions not exceeding 140° F.

13. The process of claim 11 wherein the slurry is dried during step (d) in the substantial absence of air.

14. The process of claim 11 further comprising packaging the dried active fruit product after step (d).

15. The process of claim 11 further comprising step (e) of comminuting the dried active fruit product to a roughly uniform particle size with uniform size range after step (d).

16. The process of claim 15 wherein the dried active fruit product is comminuted during step (e) to a mesh size between about 20 and about 200.

17. An active fruit supplement produced by the process recited in claim 1 which has: an Oxygen Radical Absorbance Capacity of greater than 300 micromole Trolox Equivalents per gram; phenolics (expressed as milligram gallic acid per gram) which exceed 20; and anthocyanin (expressed as milligram cyanidine-3-glucoside equivalent per gram) which exceeds 1.2.

18. A process for producing an active cranberry powder from cranberry, wherein the cranberry includes components resistant to digestion, comprising:
a. macerating the cranberry at a temperature not exceeding 140° F. to yield a cranberry pomace slurry having a particle size approximately 1 mm;
b. adding water to the cranberry during step (a), wherein water is added at a rate of 5-8% by weight;
c. adding enzymes to the slurry in an amount sufficient to provide the molecular breakdown of the cranberry, wherein the enzymes are selected from the group consisting of pectin esterase (pectinase), depolymerase, cellulase, hemicellulase, mannanase, galactosidase, xylanase and/or glucanase;
d. heating the slurry to a temperature not exceeding about 140° F.;
e. agitating the slurry for a time not to exceed four hours; and
f. drying the slurry under temperature conditions not exceeding 140° F. to a moisture content less than about 15% by weight to form a dietary supplement.

19. The process of claim 18 wherein the enzymes are added in amounts as follows:
a. Pectin esterase (pectinase) between about 0.0000001 to 2.00% by weight;
b. Depolymerase between about 0.0000001 to 2.00% by weight;
c. Cellulase between about 0.0000001 to 2.00% by weight;
d. Hemicellulase between about 0.0000001 to 2.00% by weight;
e. Mannanase between about 0.0000001 to 2.00% by weight;
f. Galactosidase between about 0.0000001 to 2.00% by weight;
g. Xylanase between about 0.0000001 to 2.00% by weight; and/or
h. Glucanase between about 0.0000001 to 2.00% by weight.

20. An active cranberry supplement produced by the process recited in claim 18 which has: an Oxygen Radical Absorbance Capacity of greater than 300 micromole Trolox Equivalents per gram; phenolics (expressed as milligram gallic acid per gram) which exceed 20; and anthocyanin (expressed as milligram cyanidine-3-glucoside equivalent per gram) which exceeds 1.2.

21. The process of claim 1 wherein step (c) is carried out at a temperature not exceeding about 100° F.

22. The process of claim 18 wherein step (c) is carried out at a temperature not exceeding about 100° F.
